(19) United States
(12) Patent Application Publication
(10) Pub. No.: US 2019/0132242 A1
(43) Pub. Date: May 2, 2019

(54) COMMUNICATION DEVICE, CONTROL METHOD, AND NON-TRANSITORY STORAGE MEDIUM

(71) Applicant: NEC Corporation, Tokyo (JP)

(72) Inventors: Kazufumi GOTA, Tokyo (JP); Takeshi HAYASHI, Tokyo (JP); Tsukasa KOBAYASHI, Tokyo (JP)

(73) Assignee: NEC Corporation, Tokyo (JP)

(21) Appl. No.: 16/173,008

(22) Filed: Oct. 29, 2018

(30) Foreign Application Priority Data
Oct. 31, 2017 (JP) 2017-210582

(51) Int. Cl. H04L 12/721; H04L 12/66; H04W 24/08; H04L 12/715

(52) U.S. Cl. CPC H04L 45/38; H04L 12/66; H04W 84/12; H04L 45/64; H04W 24/08

(57) ABSTRACT

A communication device connected to another communication device via a plurality of communication paths has: an identification unit that identifies a communication application that has established a session using a first communication path among the plurality of communication paths based on flow information on the session and system information on an operating system that operates the communication application; a control unit that decides whether or not to switch a communication path of the session from the first communication path to a second communication path among the plurality of communication paths in accordance with characteristics of the session determined from information on the communication application; and a switching unit that switches the communication path of the session in accordance with the control unit.

### INCORPORATION BY REFERENCE

This application is based upon and claims the benefit of priority from Japanese patent application No. 2017-210582, filed on Oct. 31, 2017, the disclosure of which is incorporated herein in its entirety by reference.

### TECHNICAL FIELD

The present invention relates to a communication device, a control method, and a non-transitory storage medium.

### BACKGROUND ART

Wireless networks are susceptible to interference, and the communication quality is unstable. Accordingly, a technology for measuring the communication quality in real time and selecting a communication path with good communication quality to maintain communication stability is known. Japanese Patent Application Laid-Open No. 2012-80394 discloses a data transmission device that performs a switching process of the communication path for each session in accordance with the Quality of Service (QoS) value required for each session.

### SUMMARY

In the art of Japanese Patent Application Laid-Open No. 2012-80394, however, since the QoS value required for each session is required to be predefined, there is a problem of limited sessions to be candidates for a switching process of communication paths resulting in lack of flexibility.

The present invention has been made in view of the above problem and intends to provide a communication device, a control method, and a non-transitory storage medium capable of flexibly switching a communication path for each session.

According to one example aspect of the present invention, provided is a communication device connected to another communication device via a plurality of communication paths, and the communication device has: an identification unit that identifies a communication application that has established a session using a first communication path among the plurality of communication paths based on flow information on the session and system information on an operating system that operates the communication application; a control unit that decides whether or not to switch a communication path of the session from the first communication path to a second communication path among the plurality of communication paths in accordance with the characteristics of the session determined from information on the communication application; and a switching unit that switches the communication path of the session in accordance with the control unit.

According to another example aspect of the present invention, provided is a control method of a communication device connected to another communication device via a plurality of communication paths, and the control method has steps of: identifying a communication application that has established a session using a first communication path among the plurality of communication paths based on flow information on the session and system information on an operating system that operates the communication application; deciding whether or not to switch a communication path of the session from the first communication path to a second communication path among the plurality of communication paths in accordance with the characteristics of the session determined from information on the communication application; and switching the communication path of the session in accordance with the step of deciding.

According to another example aspect of the present invention, provided is a non-transitory storage medium in which a program is stored, the program to control a communication device connected to another communication device via a plurality of communication paths, and the program causes a computer to execute steps of: identifying a communication application that has established a session using a first communication path among the plurality of communication paths based on flow information on the session and system information on an operating system that operates the communication application; deciding whether or not to switch a communication path of the session from the first communication path to a second communication path among the plurality of communication paths in accordance with the characteristics of the session determined from information on the communication application; and switching the communication path of the session in accordance with the step of deciding.

According to the present invention, a communication device, a control method, and a non-transitory storage medium capable of flexibly switching a communication path for each session are provided.

### BRIEF DESCRIPTION OF THE DRAWINGS

FIG. 1 is a block diagram illustrating a network configuration of a communication system according to a first example embodiment.

FIG. 2 is a block diagram of a controller according to the first example embodiment.

FIG. 3 is a hardware block diagram of the controller according to the first example embodiment.

FIG. 4 is a concept diagram of a process in the communication system according to the first example embodiment.

FIG. 5 is a flowchart illustrating an operation of the controller according to the first example embodiment.

FIG. 6 is a flowchart of the path decision process according to the first example embodiment.

FIG. 7A is a sequence chart of the communication system according to the first example embodiment.

FIG. 7B is a sequence chart of the communication system according to the first example embodiment.

FIG. 7C is a sequence chart of the communication system according to the first example embodiment.

FIG. 8A is a sequence chart of the communication system according to a second example embodiment.

FIG. 8B is a sequence chart of the communication system according to the second example embodiment.

FIG. 9 is a schematic configuration diagram of a communication device according to a third example embodiment.

### EXAMPLE EMBODIMENT

### First Example Embodiment

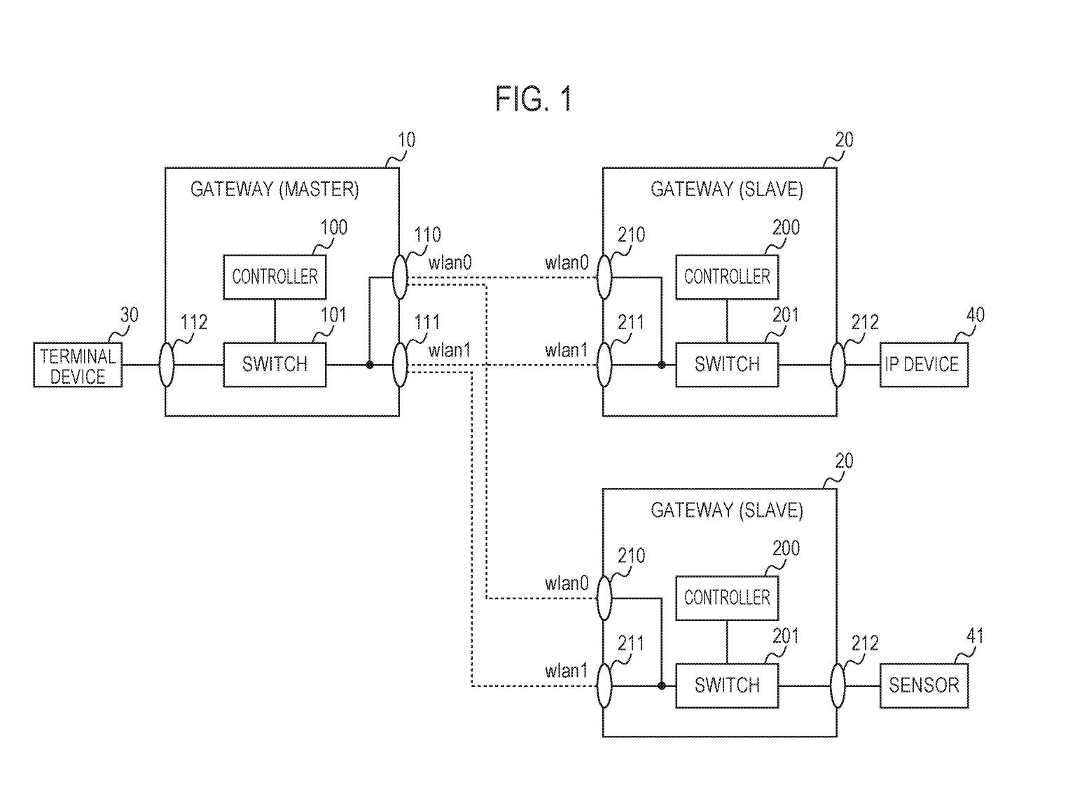

FIG. 1 is a block diagram illustrating a network configuration of a communication system according to the present example embodiment. The communication system is an in-plant system for monitoring production lines, performing quality control, or the like, for example, and has a gateway 10, gateways 20, a terminal device 30, an Internet Protocol (IP) device 40, and a sensor 41. The gateway 10 is a master device and can communicate with the gateways 20 that are slave devices by using a plurality of different wireless communication schemes.

The wireless communication scheme here may be, for example, a Wi-Fi (registered trademark) communication scheme defined by Institute of Electrical and Electronic Engineers (IEEE) 802.11a, IEEE 802.11b, IEEE 802.11g, IEEE 802.11n, IEEE 802.11ac, IEEE 802.11ah, or the like. Further, the wireless communication scheme may be a Bluetooth Low Energy (BLE) (registered trademark) communication scheme defined by IEEE 802.15.1, a ZigBee (registered trademark) communication scheme defined by IEEE 802.15.4, or the like. The wireless communication scheme may be communication in accordance with a mobile communication standard such as Long Term Evolution (LTE), 4th Generation (4G), or the like, in addition to communication of wireless Local Area Network (LAN) standard.

The gateway 10 is, for example, a communication device such as an edged computer, a mobile terminal, an embedded device, or the like and is connected to the gateways 20 via a wireless communication network. Two communication paths (wlan 0, wlan 1) with different frequencies (channels) or different wireless communication schemes are set in the wireless communication network, and communication between the gateway 10 and the gateway 20 is performed using any of these communication paths. The number of the communication paths is not limited to two, and three or more communication paths may be established.

Each of the gateways 20 is connected to a device such as the IP device 40, the sensor 41, or the like. The device is a device without a network connecting function or a device with a network connecting function and is a device on site, for example, installed inside a factory or others. The device may be a machine tool, an industrial robot, a programmable logic controller (PLC), a radio frequency identifier (RFID) tag, or the like, in addition to the IP device 40 and the sensor 41. A different device may be connected to each gateway 20. In FIG. 1, for example, the IP device 40 is connected to one gateway 20, and the sensor 41 is connected to the other gateway 20. Each gateway 20 transfers the data received from the device to the gateway 10 and transfers the data received from the gateway 10 to the device. The number of the devices connected to the gateway 20 is not limited. Hereinafter, an example in which a device is the IP device 40 will be described.

The gateway 10 has a controller 100, a switch 101, and communication interfaces 110, 111, and 112. The controller 100 is connected to the communication interfaces 110, 111, and 112 via the switch 101. The controller 100 has a function of an OpenFlow controller to which the technology of Non Patent Literature 1 (OpenFlow Switch Specification Version 1.4.0. (Wire Protocol 0x05) Oct. 14, 2013) is applied and selects a communication path used for each session based on information acquired from the switch 101. The controller 100 can control the communication path by registering a flow entry specifying the communication path to a flow table of the switch 101.

The switch 101 has a function of an OpenFlow switch to which the technology of Non Patent Literature 1 is applied and determines a transfer destination of a packet received from an external device in accordance with the flow entry. For example, the switch 101 transfers the packet received from the terminal device 30 to the communication interface 110 or the communication interface 111 in accordance with the flow entry. The flow entry is registered on the flow table in the switch 101.

The communication interfaces 110 and 111 are communication modules compatible with the wireless communication scheme described above. In FIG. 1, the communication interface 110 realizes communication in wlan 0 that is a first communication path, and the communication interface 111 realizes communication in wlan 1 that is a second communication path. Further, the communication interfaces 110 and 111 have a function for measuring communication quality (quality information) such as a communication bandwidth (a communication speed), delay, retransmission times, or the like for each communication path. The communication interface 112 is a communication module based on a standard such as Ethernet (registered trademark), Universal Serial Bus (USB), or the like and realizes a wired communication with the terminal device 30. Communication between the communication interface 112 and the terminal device 30 may be wireless. Further, the gateway 10 may be connected to the Internet via the communication interface 112 and also can transmit the data acquired from the IP device 40 via the gateway 20 to a cloud server or the like on the Internet.

A communication application program (hereinafter, a communication application) may be installed in the gateway 20, or the IP device 40 may be connected to the gateway 20. The communication application and the IP device 40 perform communication via a session established using either wlan 0 or wlan 1.

Each gateway 20 is the same communication device as the gateway 10 and connected to the gateway 10 via a wireless communication network. The number of the gateways 20 connected to one gateway 10 is not limited. The terminal device 30 is connected to the gateway 10. The terminal device 30 is, for example, a personal computer for managing the IP device 40 and transmits and receives data to and from the IP device 40 via the gateway 10 and the gateway 20.

Each gateway 20 has a controller 200, a switch 201, and communication interfaces 210, 211, and 212. The controller 200, the switch 201, and the communication interfaces 210 and 211 have the same functions as the controller 100, the switch 101, and the communication interfaces 110 and 111, respectively. The communication interface 212 is the same communication module as the communication interface 112 and realizes wired or wireless communication with the IP device 40.

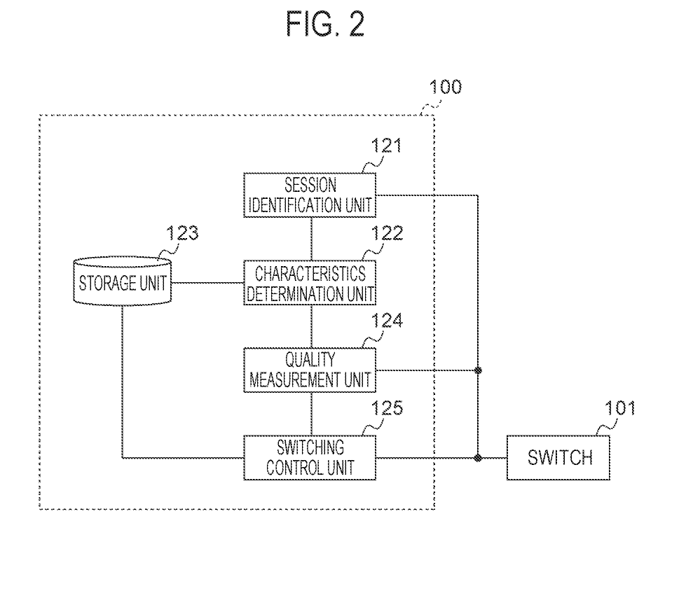

FIG. 2 is a block diagram of a controller according to the present example embodiment. The controller 100 has a session identification unit 121, a characteristics determination unit 122, a storage unit 123, a quality measurement unit 124, and a switching control unit 125. The session identification unit 121 collects statistical information on communication for each session from the switch 101. The statistical information includes the number of received packets, the number of received bytes, a session duration, and the like and, for example, and can be acquired by sending an OpenFlow statistical information acquisition request to the switch 101.

Further, the session identification unit 121 can identify a communication application or a device that has established the session based on packet information acquired from the switch 101. As described in Japanese Patent Application Laid-Open No. 2016-178530, for example, in response to receiving a Packet In message from the switch 101, the session identification unit 121 can identify a communication application based on flow information included in a Packet In message and system information on an operating system (OS) that operates the communication application.

Further, the session identification unit 121 can identify a type of data communicated in the session or a device associated with the session based on information acquired from the communication interfaces 110 or 111 via the switch 101 in addition to packet information. For example, the device can be identified based on the MAC address. Further, it is possible to decide from header information on the packet whether the packet is a packet (control packet) storing a control signal or a packet storing a data signal.

The characteristics determination unit 122 determines the characteristic of the session based on information collected by the session identification unit 121. The characteristics determination unit 122 acquires a combination of, for example, QoS, priority, and switching conditions from the storage unit 123 on a communication application basis or a device basis. These pieces of information are stored in advance for each communication application and each device in the storage unit 123. The storage unit 123 may be a remote server set outside the gateway 10.

The characteristics of the session may be that a value of requested communication speed is high, that a control packet has been transmitted, that a communication application or a device performs a large amount of data transfer in real time, or the like. High priority is set for sessions having these characteristics. Further, another characteristics of the session may be that a value of requested communication speed is low, that log data has been transmitted, that a communication application or a device transmits data which only requires a low real-time property, or the like. Low priority is set for sessions having these characteristics. Note that the characteristics described above are mere examples, and the scope of the present invention is not limited thereto. Further, a table in which priority is set for each communication application and device may be stored in the storage unit 123 in advance, and the priority of the session may be determined based on the table.

The quality measurement unit 124 monitors the actual communication data of the communication path used by the session and measures quality information on the communication path. The function of the quality measurement unit 124 may be implemented by a dedicated application program (hereinafter, referred to as a measurement application).

The switching control unit 125 decides whether or not to switch the communication path in which the session is currently established (a first communication path) to another communication path (a second communication path) based on the quality measurement result. For example, the switching control unit 125 can switch the communication path by registering a flow entry in which the communication path is defined for each session to the switch 101 by using an OpenFlow technology.

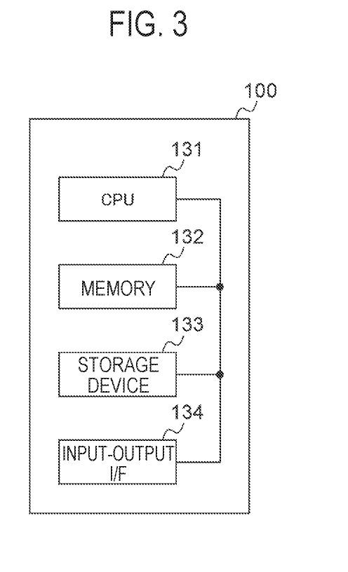

FIG. 3 is a hardware block diagram of a controller according to the present example embodiment. The controller 100 has a CPU 131, memory 132, a storage device 133, and an input-output interface (I/F) 134. The CPU 131 performs a predetermined operation in accordance with a program stored in the memory 132 or the storage device 133 and has a function of controlling each component of the controller 100. Further, the CPU 131 executes programs for implementing the functions of the session identification unit 121, the characteristics determination unit 122, the quality measurement unit 124, and the switching control unit 125.

The memory 132 is formed of a random access memory (RAM) or the like and provides a memory area required for the operation of the CPU 131. The storage device 133 may be, for example, a flash memory, a solid state drive (SSD), a hard disk drive (HDD), or the like and provides a storage area for realizing the function of the storage unit 123. The storage device 133 stores application programs or the like, a basic program such as an OS for operating the controller 100, a communication application, a measurement application, or the like. The input-output I/F 134 is an interface for performing data input and output for the switch 101 or the communication interfaces 110, 111, or 112.

Note that the hardware configuration illustrated in FIG. 3 is an example, a device other than the above may be added, and some devices may not be provided. For example, some of the functions may be provided by another device via a network, and the functions forming the present example embodiment may be implemented by being distributed among a plurality of devices.

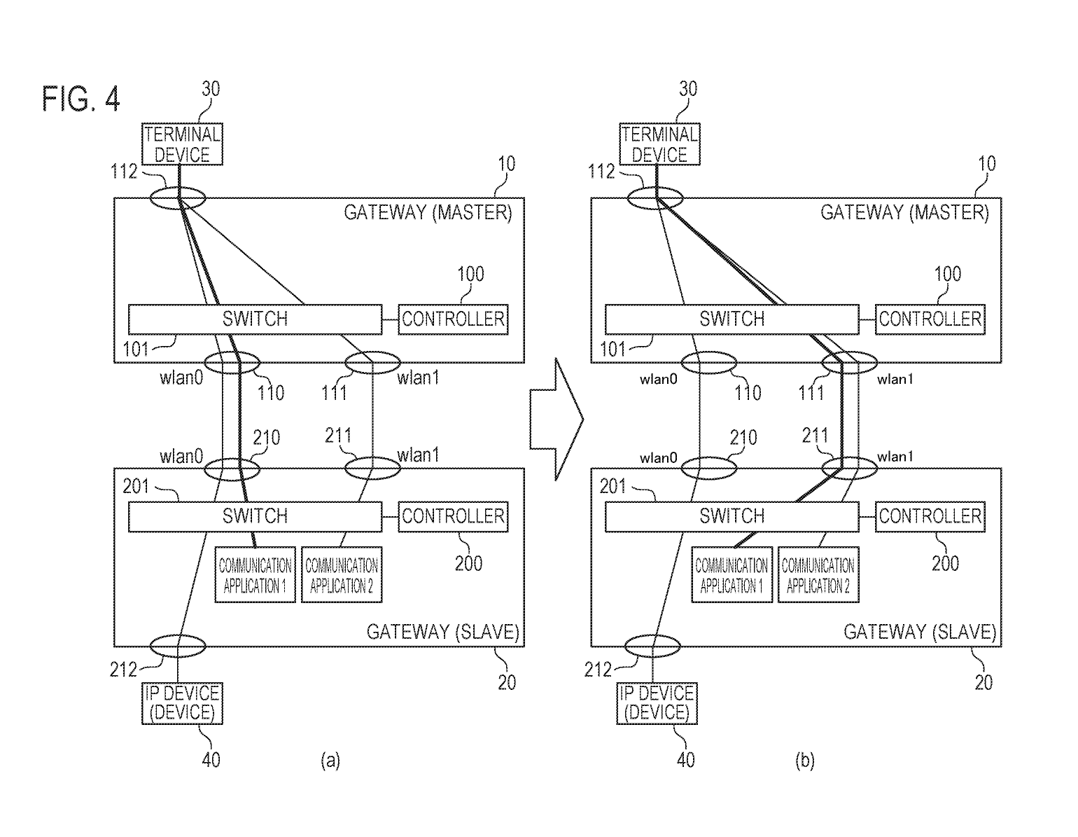

FIG. 4 is a concept diagram of a process in the communication system according to the present example embodiment and illustrates transition of communication status between the gateway 10 and the gateway 20. Between the gateway 10 and the gateway 20, communication by the terminal device 30 and the IP device 40 (device), communication by the terminal device 30 and the communication application 1, and communication by the terminal device 30 and the communication application 2 are performed, respectively. In FIG. 4(a), both of the session of the IP device 40 and the session of the communication application 1 use wlan 0, and the session of the communication application 2 uses wlan 1. The controller 100 determines priority between these sessions and measures quality information on wlan 0 and wlan 1. It is here assumed that the priority of the session of the communication application 1 is higher than the priority of the session of the IP device 40. When the quality degradation of wlan 0 is detected and the communication quality of wlan 1 is good, the controller 100 switches the communication path used for the session of the communication application 1 from wlan 0 to wlan 1. When the communication quality of wlan 1 is bad, no switching of the communication path for the communication application 1 is performed.

FIG. 4(b) illustrates the communication status after switching of the communication path. In FIG. 4(b), the session of the IP device 40 uses wlan 0, and both of the session of the communication application 1 and the session of the communication application 2 use wlan 1. As described above, in the present example embodiment, independently of the communication interface, the communication path is switched for each session of the communication application and the device. In the examples of FIG. 4(a) and FIG. 4(b), while switching of the communication path of the session of the IP device 40 is not positively performed because of the low priority, switching of the communication path of the session of the communication application 1 is positively performed because of the high priority.

Note that when the session of the communication application 1 is switched, the priority of the communication application 2 is also used as information for determination. For example, it is assumed that the priority of the communication application 2 is equal to or higher than the priority of the communication application 1. When the characteristics required for the session of the communication application 2 cannot be maintained in wlan 1 after the communication path used for the session of the communication application 1 is switched from wlan 0 to wlan 1, no switching of the communication path for the communication application 1 is performed. On the other hand, when the characteristics required for the session of the communication application 2 can be maintained in wlan 1 even after the communication path used for the session of the communication application 1 is switched from wlan 0 to wlan 1, switching of the communication path for the communication application 1 is performed. That is, an optimum communication path is selected for each session with comprehensive consideration of the relative priority between sessions, the characteristics of each session, and the communication quality of possible communication paths to be switched thereto.

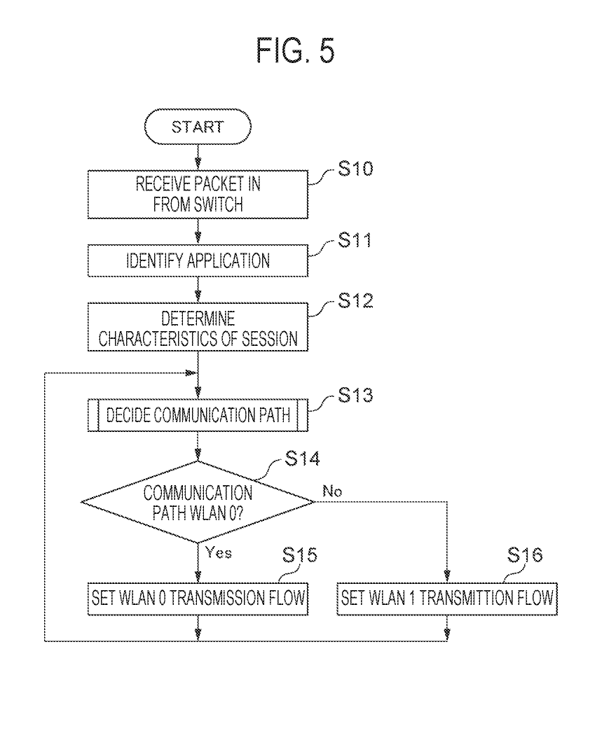

FIG. 5 is a flowchart illustrating an operation of the controller according to the present example embodiment. First, when a session is initiated by the communication application, a packet associated with the session is received in the switch 101. The switch 101 transmits a Packet In message to the controller 100 to select the communication path of the session. The controller 100 receives the Packet In message from the switch 101 (step S10).

The session identification unit 121 identifies a communication application or a device that performs the session (step S11). For example, the session identification unit 121 identifies a communication application based on flow information included in the Packet In message and information acquired from the OS. The session identification unit 121 may identify a process activated by a communication application. Further, the session identification unit 121 may identify a device associated with the session based on flow information.

Next, the characteristics determination unit 122 determines the characteristics of the session based on information on the identified communication application or the identified device (step S12). For example, the characteristics determination unit 122 acquires QoS, priority, switching conditions, or the like from the storage unit 123. The characteristics determination unit 122 may set priorities by itself, for example, when the required QoS is high, determines to perform high-quality communication as the characteristics of the session, and sets high priority of the session.

The switching control unit 125 determines the communication path used for the session (step S13). That is, the switching control unit 125 selects an optimum communication path based on quality information on each communication path measured by the quality measurement unit 124 (wlan 0, wlan 1). When the selected communication path is different from the currently used communication path, switching of the communication path will occur.

When quality information on the communication path currently used satisfies the switching condition, the switching control unit 125 may decide to switch the currently used communication path to another communication path. Further, the switching control unit 125 may decide what priority of the session each communication path is suitable for, whether or not the communication path currently used for the session is suitable for priority of the session, or the like.

When wlan 0 is selected as the communication path (step S14, YES), the switching control unit 125 sets a transmission flow of wlan 0 to the switch 101 (step S15). In the example of FIG. 4, the controller 200 registers a flow entry to the switch 201 such that a packet communicated in the session of the communication application 1 is transmitted from the communication interface 210 connected to wlan 0 (FIG. 4(a)), for example.

Further, when wlan 1 is selected as the communication path (step S14, NO), the switching control unit 125 sets the transmission flow of wlan 1 to the switch 101 (step S16). In the example of FIG. 4, the controller 200 registers a flow entry to the switch 201 such that a packet communicated in the session of the communication application 1 is transmitted from the communication interface 211 connected to wlan 1 (FIG. 4(b)), for example. The process from communication path decision to transmission flow setting (steps S13 to S16) is repeatedly performed until the session ends.

Note that, when the switching of communication path occurs as a result of decision in the path decision process (step S13), the switching control unit 125 may delay the start of the switching process in the subsequent stage (steps S14 to S16) for a predetermined time. The predetermined time is set in accordance with the characteristics or the priority of the session. For example, the predetermined time is set longer in the session with low priority than in the session with high priority. Further, the switching control unit 125 may again perform the path decision process without starting the switching process after the predetermined time has elapsed.

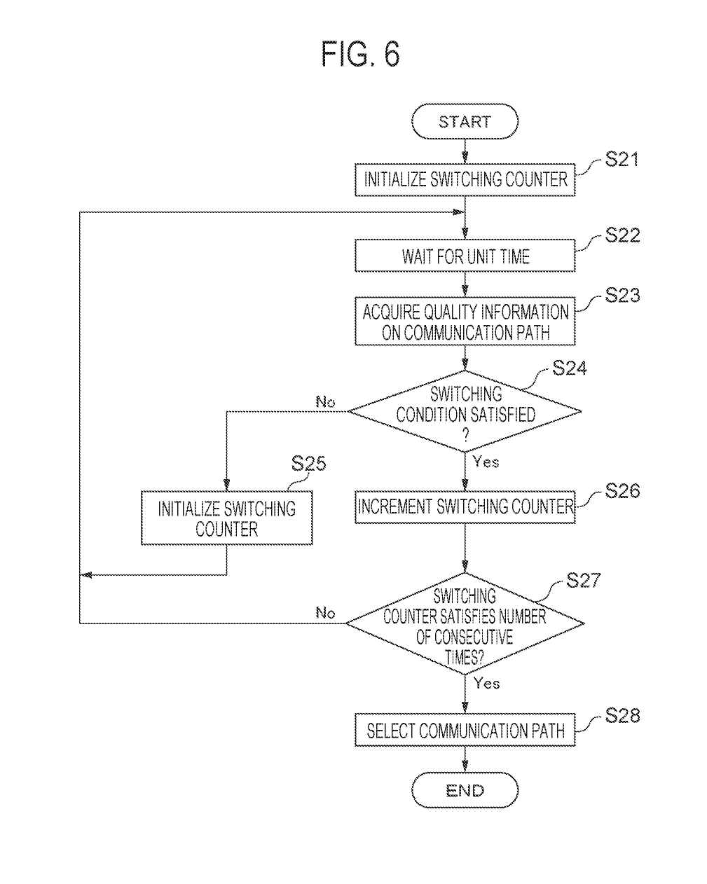

FIG. 6 is a detailed flowchart of the path decision process according to the present example embodiment. The path decision process is performed in the controller 100 for each session. First, the quality measurement unit 124 initializes a switching counter (step S21). Hereinafter, it is assumed that wlan 0 is used for the session.

The quality measurement unit 124 acquires quality information on the communication path (step S23) after waiting for a unit time (step S22). For example, the quality measurement unit 124 acquires quality information on wlan 0 and wlan 1 measured in the communication interfaces 110 and 111. Note that a unit time is the time corresponding to the repetition period and may be set to one second or the like, for example.

The switching control unit 125 determines whether or not quality information on wlan 0 satisfies the switching condition (step S24). When the switching condition is not satisfied (step S24, NO), the switching control unit 125 initializes the switching counter (step S25). When the switching condition is satisfied (step S24, YES), the switching control unit 125 increments the switching counter (step S26).

Subsequently, the switching control unit 125 determines whether or not the switching counter satisfies the number of consecutive times (step S27). The number of consecutive times may be set, for example, three to five times. When the switching counter satisfies the number of consecutive times (step S27, YES), the switching control unit 125 decides to perform switching of communication path and selects a communication path to be switched (for example, wlan 1) (step S28).

When the switching counter does not satisfy the number of consecutive times (step S27, NO), the communication path selection process (step S28) is not performed. As described above, the switching control unit 125 is configured not to immediately decide the switching when quality information satisfies the switching condition but to decide the switching when the state where quality information satisfies the switching condition continues.

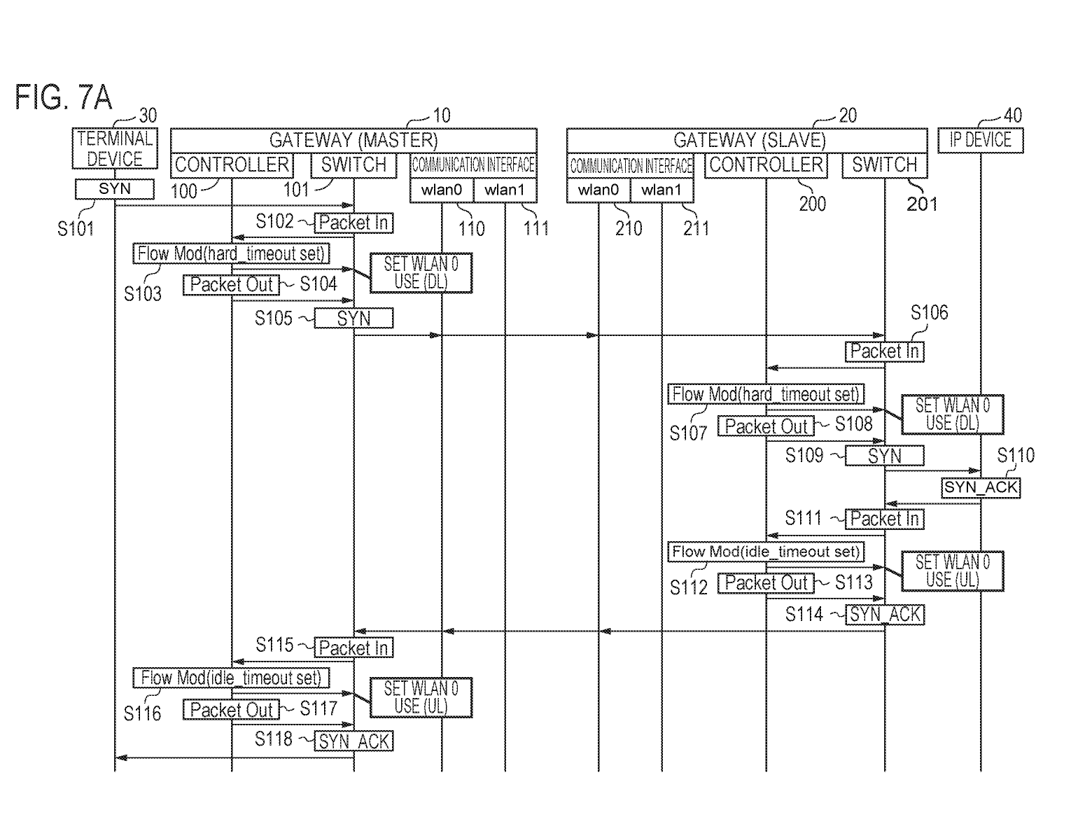

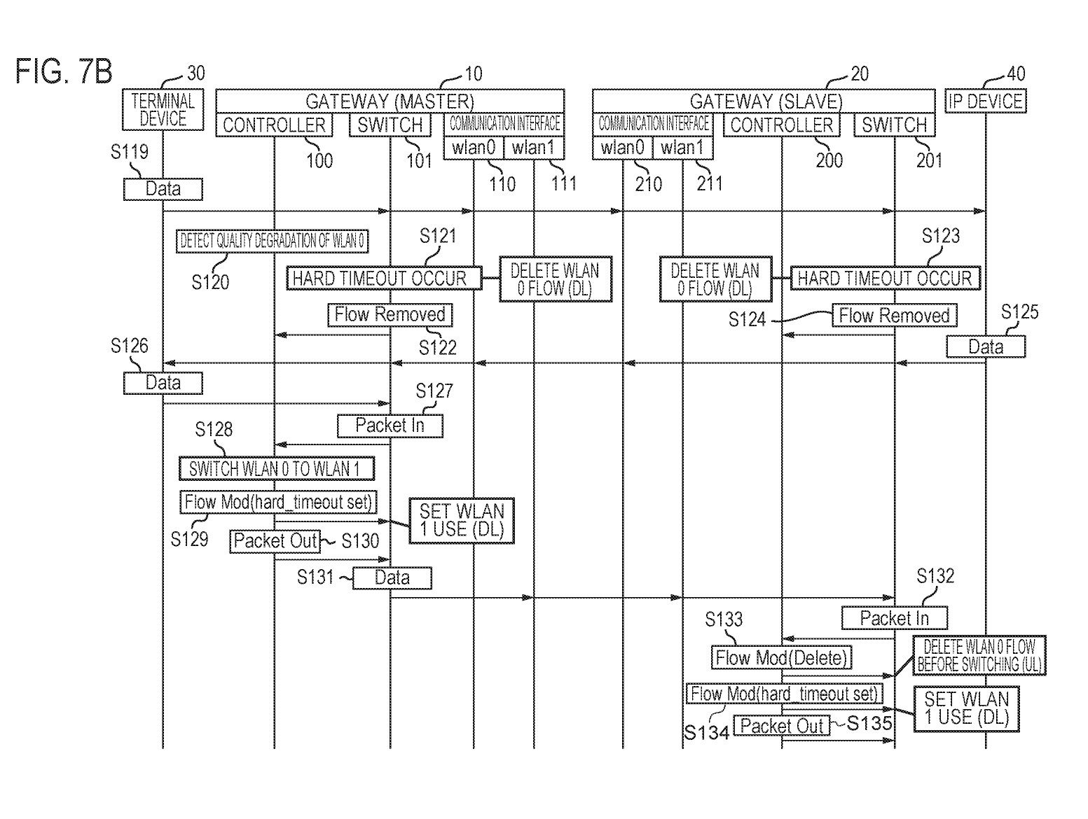

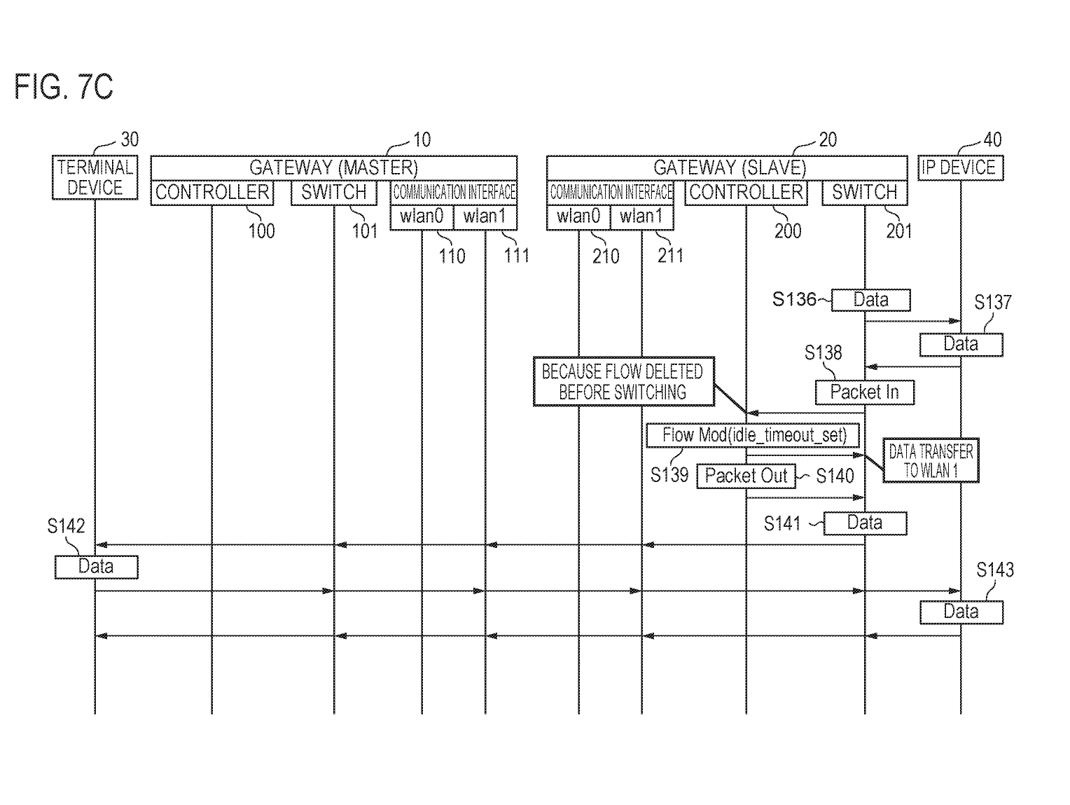

FIG. 7A, FIG. 7B, and FIG. 7C are sequence charts of the communication system according to the present example embodiment. The process when communication is performed between the terminal device 30 and the IP device 40 via the gateways 10 and 20 using the OpenFlow technology will be described here. It is assumed that a session is first established in wlan 0 and then switched to wlan 1. First, the terminal device 30 transmits a session establishment request message (SYN packet) to the gateway 10 (step S101).

In response to receiving the SYN packet from the terminal device 30, the switch 101 of the gateway 10 transfers the SYN packet to the controller 100 with a Packet In message (step S102) because the SYN packet does not match the flow entry. The controller 100 registers the flow entry to the switch 101 with a Flow Mod message (step S103) and sends the SYN packet back to the switch 101 with a Packet Out message (step S104). According to this flow entry, the transfer destination of the packet received from the terminal device 30 is designated to the communication interface 110, and the download (DL) communication path from the gateway 10 to the gateway 20 is set to wlan 0. A hard timeout is set in the Flow Mod message, and the flow entry registered here is deleted after a certain period of time.

The switch 101 transfers the SYN packet to the communication interface 110 in accordance with the flow entry (step S105). The communication interface 110 transmits the SYN packet to the communication interface 210 of the facing gateway 20 via wlan 0, and the communication interface 210 transmits the received SYN packet to the switch 201. In response to receiving the SYN packet from the communication interface 210, the switch 201 transfers the SYN packet to the controller 200 with the Packet In message (step S106) because the SYN packet does not match the flow entry.

The controller 200 registers the flow entry to the switch 201 with the Flow Mod message (step S107) and sends the SYN packet back to the switch 201 with the Packet Out message (step S108). According to this flow entry, the transfer destination of the packet received in the download from the gateway 10 to the gateway 20 is designated to the IP device 40. A hard timeout is set in the Flow Mod message, and the flow entry registered here is deleted after a certain period of time.

The switch 201 transfers the SYN packet to the IP device 40 according to the flow entry (step S109). The IP device 40 grants the session establishment request from the terminal device 30 and transmits a confirmation response message (SYN_ACK packet) to the switch 201 (step S110). In response to receiving the SYN_ACK packet from the IP device 40, the switch 201 transfers the SYN_ACK packet to the controller 200 with the Packet In message (step S111) because the SYN_ACK packet does not match the flow entry.

The controller 200 registers the flow entry to the switch 201 with the Flow Mod message (step S112) and sends the SYN_ACK packet back to the switch 201 with the Packet Out message (step S113). According to this flow entry, the transfer destination of the packet received from the IP device 40 is designated to the communication interface 210, and the upload (UL) communication path from the gateway 20 to the gateway 10 is set to wlan 0. An idle timeout is set in the Flow Mod message, and a flow entry registered here is deleted when a certain period of time being unreferenced has elapsed.

The switch 201 transfers the SYN_ACK packet to the communication interface 210 in accordance with the flow entry (step S114). The communication interface 210 transmits the SYN_ACK packet to the communication interface 110 of the facing gateway 10 via wlan 0, and the communication interface 110 transmits the received SYN_ACK packet to the switch 101. In response to receiving the SYN_ACK packet from the communication interface 110, the switch 101 transfers the SYN_ACK packet to the controller 100 with the Packet In message (step S115) because the SYN_ACK packet does not match the flow entry.

In response to receiving the Packet In message, the controller 100 registers the flow entry to the switch 101 with the Flow Mod message (step S116) and sends the SYN_ACK packet back to the switch 101 with the Packet Out message (step S117). According to this flow entry, the transfer destination of the packet received in the upload from the gateway 20 to the gateway 10 is designated to the terminal device 30. An idle timeout is set in the Flow Mod message, and a flow entry registered here is deleted when a certain period of time being unreferenced has elapsed. The switch 101 transfers the SYN_ACK packet to the terminal device 30 in accordance with the flow entry (step S118).

In response to receiving the SYN_ACK packet and confirming the session establishment, the terminal device 30 initiates data packet transmission (step S119). The data packet from the terminal device 30 is received by the IP device 40 via the switch 101, the communication interface 110, the communication interface 210, and the switch 201. That is, download communication is performed using wlan 0.

It is here assumed that the gateway 10 detects quality degradation of wlan 0 (step S120). When a certain period of time has elapsed from the registration of the flow entry in step S103, a hard timeout occurs in the switch 101, and the download flow entry is deleted (step S121). The switch 101 transmits a Flow Removed message to the controller 100 to inform that the flow entry has been deleted due to the timeout (step S122).

Similarly, when a certain period of time has elapsed from the registration of the flow entry in step S107, a hard timeout occurs in the switch 201, and the download flow entry is deleted (step S123). The switch 201 transmits the Flow Removed message to the controller 200 to inform that the flow entry has been deleted due to the timeout (step S124).

The upload flow entry remains in the switch 201, and the data packet transmitted from the IP device 40 is received by the terminal device 30 via the switch 201, the communication interface 210, the communication interface 110, and the switch 101 (step S125). That is, upload communication is performed using wlan 0.

The terminal device 30 continues to transmit the data packet to the gateway 10 (step S126). In response to receiving the data packet from the terminal device 30, the switch 101 of the gateway 10 transfers the data packet to the controller 100 with the Packet In message (step S127) because the data packet does not match the flow entry. The controller 100 decides to switch the communication path to wlan 1 in consideration of the quality degradation of wlan 0 (step S128).

The controller 100 registers a flow entry to the switch 101 with a Flow Mod message (step S129) and sends the data packet back to the switch 101 with a Packet Out message (step S130). According to this flow entry, the transfer destination of the packet received from the terminal device 30 is designated to the communication interface 111, and the download communication path from the gateway 10 to the gateway 20 is switched to wlan 1. A hard timeout is set in the Flow Mod message, and the flow entry registered here is deleted after a certain period of time.

The switch 101 transfers the data packet to the communication interface 111 in accordance with the flow entry. The communication interface 111 transmits the data packet to the communication interface 211 of the facing gateway 20 via wlan 1, and the communication interface 211 transmits the received data packet to the switch 201 (step S131). That is, download communication is performed using wlan 1.

In response to receiving the data packet from the communication interface 211, the switch 201 transfers the data packet to the controller 200 with the Packet In message (step S132) because the data packet does not match the flow entry. When receiving the Packet In message, the controller 200 deletes the upload flow entry before switching with the Flow Mod message (step S133). The controller 200 registers the flow entry to the switch 201 with the Flow Mod message (step S134) and sends the data packet back to the switch 201 by the Packet Out message (step S135). According to this flow entry, the transfer destination of the packet received in the download from the gateway 10 to the gateway 20 is designated to the IP device 40. A hard timeout is set in the Flow Mod message, and the flow entry registered here is deleted after a certain period of time.

The switch 201 transfers the data packet to the IP device 40 in accordance with the flow entry (step S136). Next, the IP device 40 transmits the data packet to the gateway 20 (step S137). The data packet transmitted here is different from the data packet received from the terminal device 30. In response to receiving the data packet from the IP device 40, the switch 201 of the gateway 20 transfers the data packet to the controller 200 with the Packet In message (step S138) because the data packet does not match the flow entry. The reason why the data packet does not match the flow entry is that the upload flow entry has been deleted in step S133.

The controller 200 registers the flow entry to the switch 201 with the Flow Mod message (step S139) and sends the data packet back to the switch 201 with the Packet Out message (step S140). According to this flow entry, the transfer destination of the packet received from the IP device 40 is designated to the communication interface 211, and the upload communication path from the gateway 20 to the gateway 10 is switched to wlan 1. An idle timeout is set in the Flow Mod message, and a flow entry registered here is deleted when a certain period of time being unreferenced has elapsed.

The switch 201 transfers the data packet to the communication interface 211 in accordance with the flow entry, and the communication interface 211 transmits the data packet to the communication interface 111 of the facing gateway 10 via wlan 1. The communication interface 111 transmits the received data packet to the switch 101, and the switch 101 transfers the data packet to the terminal device 30 (step S141). That is, upload communication is performed using wlan 1.

Thereafter, the terminal device 30 and the IP device 40 transmit and receive data packets using wlan 1. That is, the data packet from the terminal device 30 is transferred in the order of the switch 101, the communication interface 111, the communication interface 211, and the switch 201 and is received by the IP device 40 (step S142). Further, the data packet from the IP device 40 is transferred in the order of the switch 201, the communication interface 211, the communication interface 111, and the switch 101 and is received by the terminal device 30 (step S143).

According to the present example embodiment, it is possible to identify a communication application or a device that has established a session and to determine the characteristics of the session based on information on the communication application or the device. Since information on the characteristics of the session is not needed to be predefined, it is possible to switch the communication path for each session flexibly and in real time. Further, since the controller having a control function of the communication path and the switch having a switching function of the communication path are provided separately, it is possible to switch a communication path without causing packet loss during communication after the session establishment.

In the wireless network circumstance where the communication quality changes dynamically, an OpenFlow mechanism is appropriate to provide a communication path that matches the individual communication characteristics (such as QoS, latency, or the like). Application of the OpenFlow technology enables determination of a communication application or a device that performs communication and switching of a communication path in response to the communication path quality flexibly on a communication application basis and on a device basis.

In the present example embodiment, in response to receiving flow entry setting requests (Packet In messages) from the switch 101 and the switch 201 respectively, the controllers 100 and 200 respond using a Flow Mod message in which a timeout is set. In such a way, the flow entry is periodically deleted. The controllers 100 and 200 may appropriately set the time to timeout in accordance with the characteristics of the session. Since the gateway 20 selects an upload communication path so as to match the switched download communication path based on download flow information from the gateway 10, the switching of communication path is not required to be informed between the gateway 10 and the gateway 20.

### Second Example Embodiment

A communication system according to the present example embodiment is different from the first example embodiment in the method of switching communication paths. Hereinafter, the communication system according to the present example embodiment will be described focusing on a feature different from the communication system according to the first example embodiment.

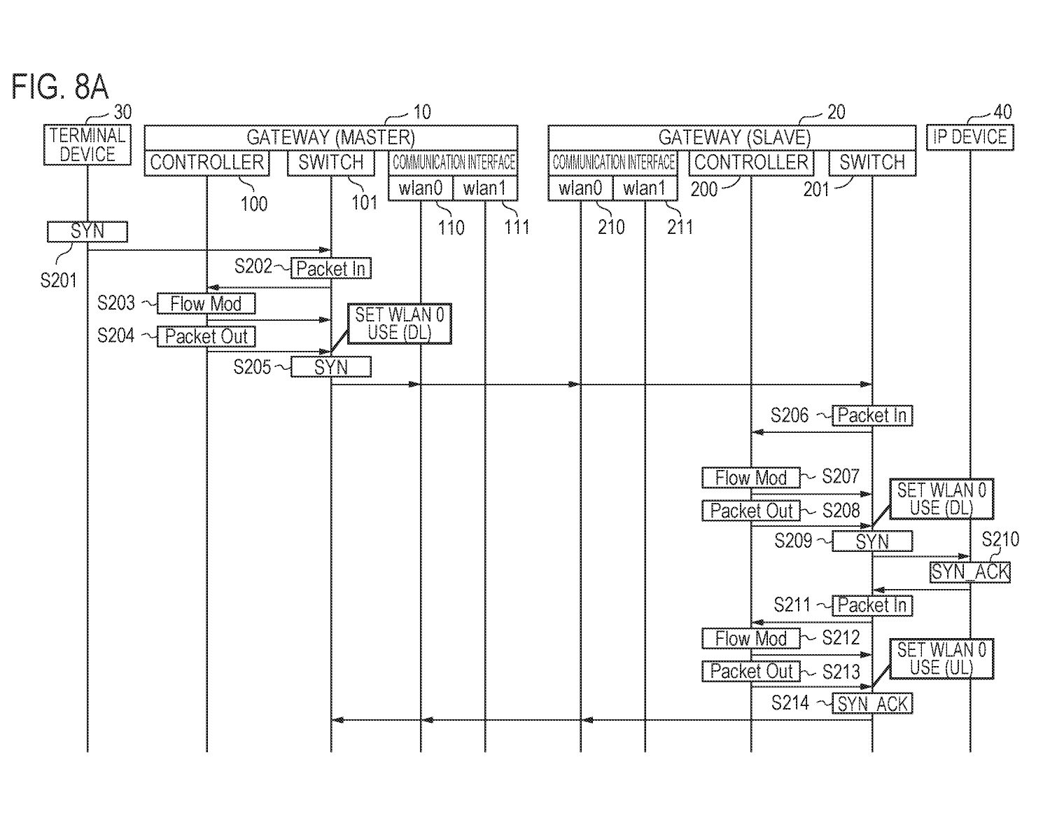

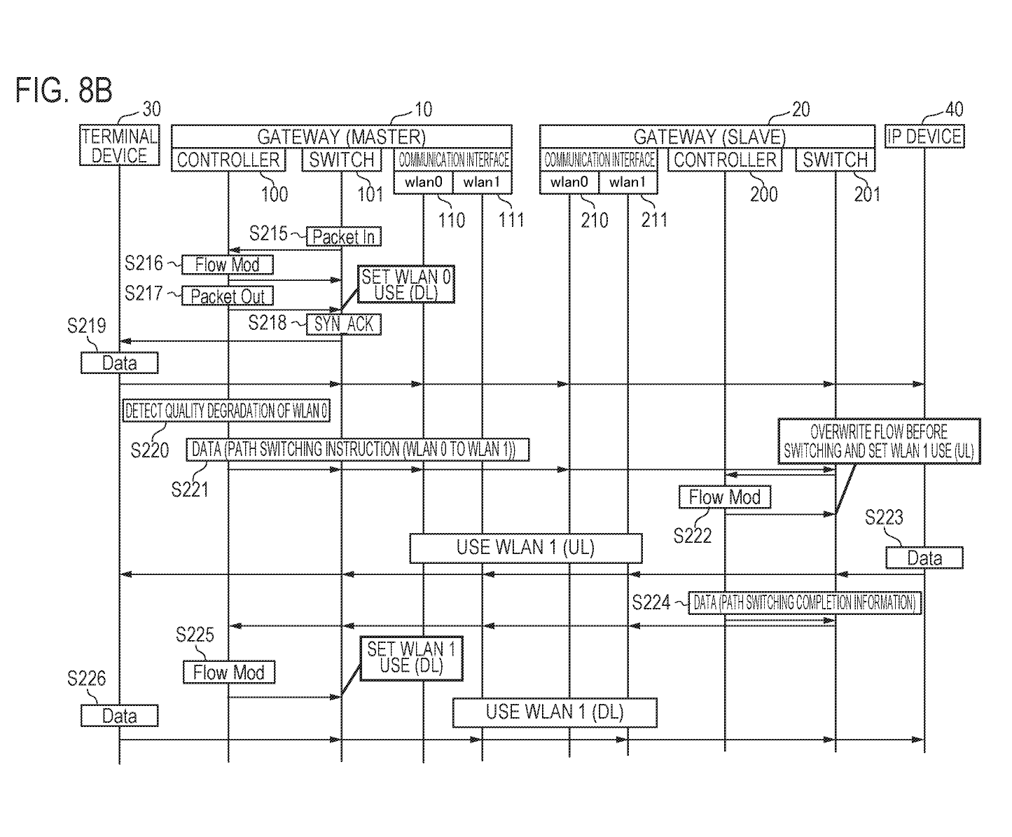

FIG. 8A and FIG. 8B are sequence charts of the communication system according to the present example embodiment. A process of communication performed between the terminal device 30 and the IP device 40 via the gateways 10 and 20 using the OpenFlow technology will be described here. It is assumed that a session is first established in wlan 0 and then switched to wlan 1. First, the terminal device 30 transmits a session establishment request message (SYN packet) to the gateway 10 (step S201).

In response to receiving a SYN packet from the terminal device 30, the switch 101 of the gateway 10 transfers the SYN packet to the controller 100 with a Packet In message (step S202) because the SYN packet does not match the flow entry. The controller 100 registers the flow entry to the switch 101 with a Flow Mod message (step S203) and sends the SYN packet back to the switch 101 with a Packet Out message (step S204). According to this flow entry, the transfer destination of the packet received from the terminal device 30 is designated to the communication interface 110, and the download (DL) communication path from the gateway 10 to the gateway 20 is set to wlan 0.

The switch 101 transfers the SYN packet to the communication interface 110 in accordance with the flow entry (step S205). The communication interface 110 transmits the SYN packet to the communication interface 210 of the facing gateway 20 via wlan 0, and the communication interface 210 transmits the received SYN packet to the switch 201.

In response to receiving the SYN packet from the communication interface 210, the switch 201 transfers the SYN packet to the controller 200 by the Packet In message (step S206) because the SYN packet does not match the flow entry.

The controller 200 registers the flow entry to the switch 201 with the Flow Mod message (step S207) and sends the SYN packet back to the switch 201 with the Packet Out message (step S208). According to this flow entry, the transfer destination of the packet received in the download from the gateway 10 to the gateway 20 is designated to the IP device 40.

The switch 201 transfers the SYN packet to the IP device 40 in accordance with the flow entry (step S209). The IP device 40 grants the session establishment request from the terminal device 30 and transmits a confirmation response message (SYN_ACK packet) to the switch 201 (step S210).

In response to receiving the SYN_ACK packet from the IP device 40, the switch 201 transfers the SYN_ACK packet to the controller 200 with the Packet In message (step S211) because the SYN_ACK packet does not match the flow entry. The controller 200 registers the flow entry to the switch 201 with the Flow Mod message (step S212) and sends the SYN_ACK packet back to the switch 201 with the Packet Out message (step S213). According to this flow entry, the transfer destination of the packet received from the IP device 40 is designated to the communication interface 210, and the upload (UL) communication path from the gateway 20 to the gateway 10 is set to wlan 0.

The switch 201 transfers the SYN_ACK packet to the communication interface 210 in accordance with the flow entry (step S214). The communication interface 210 transmits the SYN_ACK packet to the communication interface 110 of the facing gateway 10 via wlan 0, and the communication interface 110 transmits the received SYN_ACK packet to the switch 101.

In response to receiving the SYN_ACK packet from the communication interface 110, the switch 101 transfers the SYN_ACK packet to the controller 100 with the Packet In message (step S215) because the SYN_ACK packet does not match the flow entry. In response to receiving the Packet In message, the controller 100 registers the flow entry to the switch 101 with the Flow Mod message (step S216) and sends the SYN_ACK packet back to the switch 101 with the Packet Out message (step S217). According to this flow entry, the transfer destination of the packet received in the upload from the gateway 20 to the gateway 10 is designated to the terminal device 30.

The switch 101 transfers the SYN_ACK packet to the terminal device 30 in accordance with the flow entry (step S218). In response to receiving the SYN_ACK packet and confirming the session establishment, the terminal device 30 initiates data packet transmission (step S219). The data packet from the terminal device 30 is received by the IP device 40 via the switch 101, the communication interface 110, the communication interface 210, and the switch 201. That is, download communication is performed using wlan 0. Similarly, upload communication is performed using wlan 0.

When quality degradation of wlan 0 is detected (step S220) and the switching condition is satisfied, the gateway 10 informs the gateway 20 of a data packet including the switching instruction to switch the communication path from wlan 0 to wlan (step S221). This data packet is transmitted from the controller 100 to the controller 200 via the switch 101, the communication interface 110, the communication interface 210, and the switch 201. The controller 200 overwrites the flow entry of the switch 201 with the Flow Mod message in accordance with the switching instruction (step S222). In such a way, the transfer destination of the packet received in the download from the gateway 10 to the gateway 20 is designated to the IP device 40. Further, the transfer destination of the packet received from the IP device 40 is designated to the communication interface 211, and the upload communication path from the gateway 20 to the gateway 10 is switched to wlan 1.

The data packet transmitted from the IP device 40 is received by the terminal device 30 via the switch 201, the communication interface 211, the communication interface 111, and the switch 101 (step S223). That is, upload communication is performed using wlan 1.

The gateway 20 informs the gateway 10 of switching completion information indicating that the switching of communication path is completed (step S224). The switching completion information is transmitted from the controller 200 to the controller 100 via the switch 201, the communication interface 211, the communication interface 111, and the switch 101. In accordance with the switching completion information, the controller 100 overwrites the flow entry registered to the switch 101 with the Flow Mod message (step S225). In such a way, the transfer destination of the packet received in the upload from the gateway 20 to the gateway 10 is designated to the terminal device 30. Further, the transfer destination of the packet received from the terminal device 30 is designated to the communication interface 111, and the download communication path from the gateway 10 to the gateway 20 is switched to wlan 1.

The data packet transmitted from the terminal device 30 is received by the IP device 40 via the switch 101, the communication interface 111, the communication interface 211, and the switch 201 (step S226). That is, download communication is performed using wlan 1.

As described above, in the present example embodiment, information on the switching of communication path is informed between the gateway 10 and the gateway 20. In response to receiving a switching instruction from the gateway 10, the gateway 20 switches the upload communication path by overwriting the flow entry for each session. Upon receiving switching completion from the gateway 20, the gateway 10 switches the download communication path on a session basis.

### Third Example Embodiment

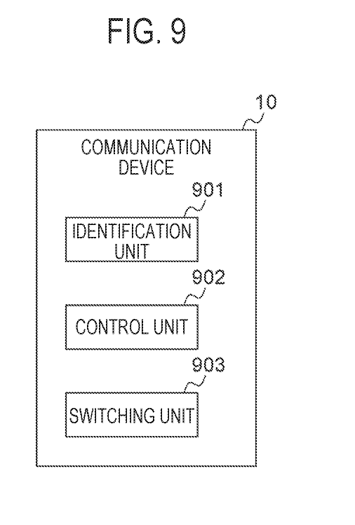

FIG. 9 is a schematic configuration diagram of a communication device according to the present example embodiment. The communication device 10 is a communication device connected to another communication device via a plurality of communication paths and has an identification unit 901, a control unit 902, and a switching unit 903. The identification unit 901 identifies a communication application that has established a session using a first communication path among the plurality of communication paths based on flow information on the session and system information on an OS that operates the communication application. The control unit 902 decides whether or not to switch the communication path from the first communication path to a second communication path among the plurality of communication paths in accordance with the characteristics of the session determined from information on the communication application. The switching unit 903 switches the communication path of the session according to the control unit 902.

### Modified Example Embodiments

The present example embodiment is not limited to the example embodiments described above and can be appropriately modified within the scope not departing from the spirit of the present invention. While the controller 100 is described as a controller having a function of the OpenFlow controller in the example embodiments described above, for example, the function of the OpenFlow controller may be provided separately from the controller 100. Further, the present invention is not limited to the OpenFlow technology and can also be realized by another technology in which the controller 100 can control switching of the communication path by the switch 101.

The whole or part of the example embodiments disclosed above can be described as, but not limited to, the following supplementary notes.

(Supplementary Note 1)

A communication device connected to another communication device via a plurality of communication paths, the communication device comprising:

an identification unit that identifies a communication application that has established a session using a first communication path among the plurality of communication paths based on flow information on the session and system information on an operating system that operates the communication application;

a control unit that decides whether or not to switch a communication path of the session from the first communication path to a second communication path among the plurality of communication paths in accordance with characteristics of the session determined from information on the communication application; and

a switching unit that switches the communication path of the session in accordance with the control unit.

(Supplementary Note 2)

The communication device according to supplementary note 1, wherein the identification unit identifies a device associated with the session based on the flow information, and the characteristics of the session are determined from at least one of information on the communication application and information on the device.

(Supplementary Note 3)

The communication device according to supplementary note 1 or 2 further comprising a measurement unit that measures quality information on each of the plurality of the communication paths, wherein the control unit decides switching of the communication path in accordance with the quality information.

(Supplementary Note 4)

The communication device according to supplementary note 3, wherein the control unit decides switching to the second communication path when the quality information of the first communication path satisfies a predetermined switching condition set on a communication application basis or on a device basis.

(Supplementary Note 5)

The communication device according to any one of supplementary notes 1 to 4, wherein the control unit initiates a switching process to perform the switching after a predetermined period of time has elapsed from decision of switching of the communication path.

(Supplementary Note 6)

The communication device according to supplementary note 5, wherein the control unit again decides the switching without initiating the switching process after the predetermined period of time has elapsed.

(Supplementary Note 7)

The communication device according to supplementary note 5 or 6, wherein the predetermined period of time is determined in accordance with the characteristics of the session.

(Supplementary Note 8)

The communication device according to any one of supplementary notes 1 to 7, wherein the flow information includes statistical information on a communication by the session or a type of data communicated in the session.

(Supplementary Note 9)

The communication device according to any one of supplementary notes 1 to 8, wherein the plurality of communication paths are set on a wireless communication network by a plurality of different wireless communication schemes.

(Supplementary Note 10)

The communication device according to any one of supplementary notes 1 to 9, wherein the control unit informs the another communication device of information on the second communication path.

(Supplementary Note 11)

The communication device according to any one of supplementary notes 1 to 10, wherein the control unit includes a function of an OpenFlow controller, and the switching unit includes a function of an OpenFlow switch.

(Supplementary Note 12)

The communication device according to supplementary note 11, wherein the control unit periodically deletes a flow entry registered in the OpenFlow switch and, in accordance with a setting request from the OpenFlow switch, registers a flow entry based on information on the second communication path to the OpenFlow switch.

(Supplementary Note 13)

The communication device according to supplementary note 11, wherein the control unit overwrites a flow entry registered in the OpenFlow switch based on information on the second communication path.

(Supplementary Note 14)

A control method of a communication device connected to another communication device via a plurality of communication paths, the control method comprising steps of:

identifying a communication application that has established a session using a first communication path among the plurality of communication paths based on flow information on the session and system information on an operating system that operates the communication application;

deciding whether or not to switch a communication path of the session from the first communication path to a second communication path among the plurality of communication paths in accordance with characteristics of the session determined from information on the communication application; and

switching the communication path of the session in accordance with the step of deciding.

(Supplementary Note 15)

A program that controls a communication device connected to another communication device via a plurality of communication paths, the program causing a computer to execute steps of:

identifying a communication application that has established a session using a first communication path among the plurality of communication paths based on flow information on the session and system information on an operating system that operates the communication application;

deciding whether or not to switch a communication path of the session from the first communication path to a second communication path among the plurality of communication paths in accordance with characteristics of the session determined from information on the communication application; and

switching the communication path of the session in accordance with the step of deciding.

What is claimed is:

1. A communication device connected to another communication device via a plurality of communication paths, the communication device comprising:
an identification unit that identifies a communication application that has established a session using a first communication path among the plurality of communication paths based on flow information on the session and system information on an operating system that operates the communication application;
a control unit that decides whether or not to switch a communication path of the session from the first communication path to a second communication path among the plurality of communication paths in accordance with characteristics of the session determined from information on the communication application; and
a switching unit that switches the communication path of the session in accordance with the control unit.

2. The communication device according to claim 1, wherein the identification unit identifies a device associated with the session based on the flow information, and the characteristics of the session are determined from at least one of information on the communication application and information on the device.

3. The communication device according to claim 1 further comprising a measurement unit that measures quality information on each of the plurality of the communication paths,
wherein the control unit decides switching of the communication path in accordance with the quality information.

4. The communication device according to claim 3, wherein the control unit decides switching to the second communication path when the quality information of the first communication path satisfies a predetermined switching condition set on a communication application basis or on a device basis.

5. The communication device according to claim 1, wherein the control unit initiates a switching process to perform the switching after a predetermined period of time has elapsed from decision of switching of the communication path.

6. The communication device according to claim 5, wherein the control unit again decides the switching without initiating the switching process after the predetermined period of time has elapsed.

7. The communication device according to claim 5, wherein the predetermined period of time is determined in accordance with the characteristics of the session.

8. The communication device according to claim 1, wherein the flow information includes statistical information on a communication by the session or a type of data communicated in the session.

9. The communication device according to claim 1, wherein the plurality of communication paths are set on a wireless communication network by a plurality of different wireless communication schemes.

10. The communication device according to claim 1, wherein the control unit informs the another communication device of information on the second communication path.

11. The communication device according to claim 1, wherein the control unit includes a function of an OpenFlow controller, and the switching unit includes a function of an OpenFlow switch.

12. The communication device according to claim 11, wherein the control unit periodically deletes a flow entry registered in the OpenFlow switch and, in accordance with a setting request from the OpenFlow switch, registers a flow entry based on information on the second communication path to the OpenFlow switch.

13. The communication device according to claim 11, wherein the control unit overwrites a flow entry registered in the OpenFlow switch based on information on the second communication path.

14. A control method of a communication device connected to another communication device via a plurality of communication paths, the control method comprising steps of:
identifying a communication application that has established a session using a first communication path among the plurality of communication paths based on flow information on the session and system information on an operating system that operates the communication application;
deciding whether or not to switch a communication path of the session from the first communication path to a second communication path among the plurality of communication paths in accordance with characteristics of the session determined from information on the communication application; and
switching the communication path of the session in accordance with the step of deciding.

15. A non-transitory storage medium in which a program is stored, the program that controls a communication device connected to another communication device via a plurality of communication paths, the program causing a computer to execute steps of:
identifying a communication application that has established a session using a first communication path among the plurality of communication paths based on flow information on the session and system information on an operating system that operates the communication application;
deciding whether or not to switch a communication path of the session from the first communication path to a second communication path among the plurality of communication paths in accordance with characteristics of the session determined from information on the communication application; and
switching the communication path of the session in accordance with the step of deciding.
